(19) United States
(12) Patent Application Publication
(10) Pub. No.: US 2026/0014493 A1
(43) Pub. Date: Jan. 15, 2026

(54) METHOD FOR EXTRACTING A METAL ION FROM AN EARTH MATERIAL

(71) Applicant: Schlumberger Technology Corporation, Sugar Land, TX (US)

(72) Inventors: Dean Michael Willberg, Sugar Land, TX (US); Dominic Vincent Perroni, Sugar Land, TX (US); Pavani Cherukupally, Cambridge, MA (US); Shawn David Taylor, Cambridge, MA (US)

(21) Appl. No.: 19/027,133

(22) Filed: Jan. 17, 2025

Related U.S. Application Data
(60) Provisional application No. 63/671,335, filed on Jul. 15, 2024.
(60) Provisional application No. 63/671,331, filed on Jul. 15, 2024.

(51) Int. Cl. B01D 11/02; C01D 15/02; C01D 15/08; C22B 3/16; C22B 4/02; C22B 26/12

(52) U.S. Cl. CPC B01D 11/0211; C01D 15/02; C01D 15/08; C22B 3/16; C22B 4/02; C22B 26/12

(57) ABSTRACT

Described herein are methods of recovering metal ions from thermally treated earth materials and/or making polymers from the thermally treated earth materials. A thermally treated earth material is obtained, for example by treating an earth material using plasma, microwaves, flash calcination, or any combination thereof. A metal is removed from the thermally treated earth material, for example by mixing with an organic solvent or aqueous solution having pH less than about 9. The remaining earth material is alkali reactive and can be formed into an aluminosilicate polymer by exposure to a high pH aqueous solution.

### FIELD

This patent application describes methods and apparatus for recovering metal ions. Specifically, processes for recovering metal ions from thermally-treated earth materials are described herein.

### BACKGROUND

Lithium is a key element in energy storage. Electrical storage devices, such as batteries, supercapacitors, and other devices commonly use lithium to mediate the storage and release of chemical potential energy as electrical current. As demand for renewable, but non-transportable, energy sources such as solar and wind energy grows, demand for technologies to store energy generated using such sources also grows.

According to the United States Geological Survey, global reserves of lithium totalled about 26 million tons (metric) of lithium content at the end of 2022, with Chile, Australia, Argentina, and China accounting for about 78% of global reserves. U.S. Geological Survey, Mineral Commodity Summaries, January 2023. Reuters reported that lithium supply was forecast to be 964 KT LCE in 2023, up from 737 kT in 2022. According to S&P Global Commodity Insights, lithium demand was expected to outpace supply by 3% in 2023, and every year thereafter until 2027. By 2028, global lithium demand is expected to double to over 2,000 kTa, while production is set to rise to 2,100 kTa. While lithium prices are quite volatile as the global market develops, lithium prices are expected to remain high through 2030. The incentive for more lithium production could not be clearer.

Lithium can be extracted from loose earth materials, such as clays, using known methods of leaching. These processes generally yield aqueous lithium-containing solutions with low concentrations of lithium, along with other materials. An efficient and effective process is needed for recovering lithium, and other ions of interest, from earth materials . . . .

### SUMMARY

Embodiments described herein provide a method, comprising obtaining a thermally treated earth material containing a metal; removing the metal from the thermally treated earth material to form a dilute metal solution; and recovering the metal from the dilute metal solution or a derivative thereof using a selective recovery process.

### BRIEF DESCRIPTION OF THE DRAWINGS

FIG. 1 is a schematic elevation view of a plasma activation apparatus for an earth material.

FIG. 2 is a schematic process diagram of a process-flow diagram of a metal recovery process according to one embodiment.

FIG. 3A is a schematic side view of a continuous flow microwave treatment apparatus for treating earth materials according to one embodiment.

FIG. 3B is a schematic side view of a continuous flow microwave treatment apparatus for treating earth materials according to another embodiment.

FIG. 3C is a schematic side view of a continuous flow microwave treatment apparatus according to another embodiment.

FIG. 3D is a schematic side view of a microwave treatment apparatus according to another embodiment.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term “about” should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific data points, it is to be understood that inventors appreciate and understand that any data points within the range are to be considered to have been specified, and that inventors possessed knowledge of the entire range and the points within the range.

Regarding chemical formulas, it should be noted that measurements may not conform precisely to the chemical formulas described herein due to various sources of error that can affect real-world testing. The chemical formulas described herein should therefore be understood as expressing the nominal chemical makeup of compounds, where real-world testing may show close, but not exact, conformity to the formulas.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Geopolymer materials, and other alkali activated materials, are formed by disposing one or more sources of oxidized aluminum and silicon, along with an alkali activator in a water mixture. Some materials used to make alkali-activated materials also contain calcium. The alkali activator produces a high pH aqueous solution that activates polymerization of the aluminum, silicon, and oxygen to form a hard aluminosilicate polymer material. Generally, alkali reactive materials are exposed to aqueous activator solutions having pH of about 10 or higher, for example about 11 or higher, in most cases to form an aluminosilicate polymer. The methods described herein use earth materials containing aluminum, silicon, and oxygen to manufacture alkali activated materials and polymers. The earth materials are treated using a thermal treatment process to form treated earth materials that can react to form geopolymers and other alkali activated and/or cementitious materials. Where other elements of interest may be present in the earth materials, the treated earth materials, or both, such as metal ions, such ions can optionally be extracted before the treated earth material is used to make a polymer.

Aluminosilicate polymer materials are generally useful where cementitious materials are desired, for example in surface construction applications or subterranean applications, for example well drilling and completion. In some embodiments, a wellbore may be used for carbon capture, utilization, and storage (CCUS) and/or for recovery and use of geothermal energy. Geothermal energy is a promising source of renewable energy that captures energy from heat generated or stored within the earth. For example, geothermal energy may be used to perform climate control (e.g., heating, cooling) for structures (e.g., buildings) using heat pumps and/or to generate electricity (e.g., by heating water to generate steam and drive a turbine with the steam). The wellbores described herein may be used to circulate a working fluid that exchanges heat within the earth formation through which the wellbore extends. The working fluid may be circulated to the surface where a surface heat exchanger is used to transfer thermal energy to another fluid used to generate electricity and/or for climate control. After the thermal energy is transferred from the working fluid in the surface heat exchanger, the working fluid is circulated back to the earth formation to continue the cycle.

CCUS facilitates the capture, use, and/or storage of carbon (e.g., carbon dioxide), which has a goal of achieving carbon neutrality and/or net zero carbon emissions (NZE). Carbon capture may include the capture of carbon dioxide from large point sources, such as power plants, refineries, cement plants, other industrial processing plants, or other industrial facilities that use fossil fuels, biomass fuels, or other fuels that generate carbon dioxide. The captured carbon dioxide may be converted into valuable products such as, for example, ethanol, sustainable aviation fuel, chemicals, mineral aggregates, and/or other products. Alternatively, the carbon dioxide may be stored in geologic formations, such as in depleted hydrocarbon reservoirs. The carbon dioxide may be introduced into the earth formation through a wellbore, such as the wellbores described herein. In the earth formation, the carbon in the carbon dioxide may be dispersed in an aqueous phase and stored as carbon dioxide, may be stored in mineral form (e.g., as a carbonate, such as calcium carbonate, magnesium carbonate, iron (II) carbonate), or as another form of carbon.

The earth material can be any material obtained from the earth that contains suitable quantities of aluminum, silicon, and oxygen, and optionally calcium or other metals. Such materials may be aluminosilicate materials. The general chemical formula of an aluminosilicate polymer is Mₙ {—(SiO₂)_{z}—AlO₂}ₙ·w H₂O, wherein M is a cation such as potassium, sodium or calcium, n is a degree of polymerization and z is the Si/Al atomic ratio. Thus, for purposes of making an aluminosilicate polymer the earth material should have significant quantity of aluminum, silicon, and oxygen, but otherwise any earth material, such as sand, gravel, rock, soil, or another earth material that is rendered to a form that can be flowed or disposed for thermal treatment. The earth material can be a damp solid or an aqueous slurry in some cases. The aqueous medium for the aqueous slurry contains water, and may be water, but may also contain dissolved ions such as metal salts and organic salts.

Clays of various forms are suitable earth materials for use with the methods and apparatus described herein. Clays containing metal ions are attractive because the thermal treatments herein using plasma and/or microwaves can improve extraction of the metal ions in addition to providing a product that can undergo alkali activated polymerization. The clays can be, or can contain, particles, sheets, 1:1 layered domains, 2:1 layered domains, ordered domains, and disordered domains that response in various ways, and to varying degrees, to the treatments described herein. In some cases, the thermal treatments described herein rearrange atoms in the earth materials to create metastable structures having low crystallinity, which are suited to metal extraction methods and are prone to alkali activated polymerization. Examples of materials suitable for the methods herein include smectite, illite, montmorillonite, mica, chlorite, kaolinite, hectorite, boron clay, bauxite clay, and other related materials.

In an embodiment, the thermal treatment includes a plasma process. The plasma process herein is a thermal plasma process that raises a temperature of the earth material to a threshold that activates at least a portion of the aluminum, silicon, and oxygen in the earth material to a state that can react in a high pH aqueous medium. The plasma process can also cause rearrangement of crystal structures within the earth material to simplify extraction of valuable metals from the earth material. An electric arc furnace can be used to treat the earth material. In an electric arc furnace, the earth material is passed between two electrodes between which a high voltage electric discharge is maintained, exposing the earth material directly to the electric arc to raise a temperature of the earth material to a high temperature, for example at least about 700 K and in some cases to 3,500 K or higher, to yield a treated earth material. The electrodes define a spark gap across which a high voltage causes a plasma discharge between the two electrodes. Exposure to the plasma discharge can heat the earth material to the high temperatures described above in milliseconds to perform a “flash” thermal treatment, which can be a flash calcination treatment. Such electric arc furnaces are commonly used to treat numerous materials at high temperatures, and can be used to treat a material that contains aluminum, silicon, and oxygen for alkali activated polymerization. The treated earth material having sufficient aluminum, silicon, and oxygen content may be modified by the treatment such that the treated earth material can be used to make alkaline activated polymers. The treated earth material may also be modified by the treatment to simplify extraction of metals from the earth material. In some cases, it is believed that the high temperature treatment changes crystal structures of the earth material to increase mobility of metal ions within the earth material, thus simplifying extraction of metals from the treated earth material.

Generally, flash calcination is a thermal treatment process in which an earth material is heated to a target temperature in a very short period of time. The flash calcination process accomplishes structural and chemical changes in the earth material that are similar to the changes observed in conventional calcination processes, reducing hydration and forming higher energy crystal structures, but the flash calcination process involves a very high rate of heating, for example rates exceeding 105 K/sec, and in some cases exceeding 10⁶ K/sec. The target temperature is generally at least about 600 K, but can be 3,000 K or higher, such as 3,500 K. In flash calcination, the target temperature can be reached in milliseconds, for example 10-50 msec. Flash calcination can be performed using any energy source capable of providing the energy flux needed to raise the temperature of the earth material quickly. In many cases, the earth material is rapidly passed through a zone of very high thermal energy such that the earth material has a very short residence time in the zone of very high thermal energy, for example less than 100 msec. In some cases, the energy can be provided by fuel combustion, and in other cases, as described below, the energy can be provided by radiation and/or plasma discharge.

Combinations of energy sources can also be used. For example, a thermal energy source, such as fuel combustion, can be combined with a radiation source and/or a plasma discharge. The combination of energy sources can be co-located in a single zone, in a plurality of overlapping zones, or in a plurality of zones any of which can be spaced apart from the other zones. For flash calcination to occur, the zones must be configured such that the energy exposure of the earth material in the zones results in the earth material reaching the target temperature at which chemical and physical transformations occur in a very short time, for example less than 100 msec.

Flash calcination can be used to form thermally treated earth materials from which metals can be readily extracted. Earth materials such as various types of clays, as described elsewhere herein, often contain valuable metals. Treating such clays, or other metal containing earth materials, using flash calcination in any of the forms described herein, can improve yield of metals extracted from the earth materials. The chemical and physical changes resulting from the flash calcination process make metal extraction from the earth materials easier, advantageously increasing the yield of such extraction processes, including the various extraction processes described herein. Thus, performing a flash calcination process on an earth material to form a treated earth material, and then extracting metal from the treated earth material, for example by leaching, can form a useful aqueous solution of metal ions from which target metals can be recovered by processes described herein.

In an electric arc furnace process, earth material is introduced, either in batches or continuously, to a space where an electric arc discharge is maintained or created to directly contact the earth material. The earth material is caused to reside in substantial contact or adjacency with the plasma discharge so that the earth material remains at a high temperature for a duration sufficient to rearrange the aluminum, silicon, and oxygen of the earth material to a state that is reactive in a high pH aqueous environment. The very high temperatures available from plasma discharges make it possible to accomplish the transformation of an earth material in fractions of a second in many cases. The transformation of the earth material can include transforming the material from a substantially crystalline morphology to a substantially amorphous morphology. In other cases, crystallinity of the material is merely reduced. In some cases, clay materials can exfoliate small sheets or platelets of the clay material during treatment.

In one version of the electric discharge plasma process, the earth material is disposed in an aqueous medium for plasma treatment. The resulting mixture may be a mud or a slurry. The mixture is exposed to the electric arc to create an electrohydraulic discharge that, together with thermal energy from the electric arc, transforms the earth material into an alkali activated state. In another version of the electric discharge plasma process, the earth material is fluidized in an ionizable gas such as nitrogen or argon. The earth material can be reduced in size to fine particles to facilitate fluidization. The fluidized earth material is flowed through the space hosting the electric discharge, and the ionizable gas ionizes while the earth material is heated to a high temperature. Ionization of the ionizable gas supports the electric discharge and contributes to the thermal energy applied to the earth material. In another version of the electric discharge plasma process, the earth material is introduced as a solid, using a screw feeder, conveyor, or by gravity, to the reaction space.

Other versions of plasma treatment can also be used. For example, a plasma torch can be used to create a plasma environment that raises the temperature of the earth material. In such processes, the earth material is passed through a space in which a plasma from a plasma torch, either electrically energized or energized using fuel, is maintained. As in the electric arc version above, the earth material is exposed to the plasma for a duration sufficient to activate the aluminum, silicon, and oxygen in the earth material to an alkaline reactive state.

In addition to, or in combination with, plasma treatment, earth materials can be treated for use in an alkali-activated material by heat treating using a microwave apparatus. Microwave energy can be used to heat an earth material, as a dry solid or in slurry form. Thermal energy and/or microwave energy can be applied along with plasma energy from other sources or mechanisms (such as electric discharge described above), concurrently or sequentially, to raise the temperature of the material to a level that results in alkali reactivity. Such treatments can also be applied cyclically, where convenient and appropriate. Thus, for example, a first treatment can include any or all of plasma exposure, microwave exposure, and exposure to thermal energy, and then a second treatment can include any or all of plasma exposure, microwave exposure, and exposure to thermal energy, where at least one treatment includes exposure to plasma or microwave energy. Any suitable thermal treatment, or combination of such treatments, can be used.

The earth material can be combined with other materials prior to thermal treatment. Materials such as water, calcium hydroxide, calcium oxides, salts, quartz sand, fuels, oxidizers, metals, cellulosic materials, lignins, coke, and/or graphite can be added to the earth material prior to thermal treatment. Fusion salts, molten or meltable salts, ammonium salts, charcoal, and graphene can also be added to increase electrical conductivity of the earth material to promote maintenance of plasma and/or increase capacity of plasma treatment and/or to promote selectivity for metal extraction. Fusion salts can include alkali metal carbonates such as sodium or potassium carbonate and alkali metal or alkaline earth metal sulfates such as sodium sulfate and barium sulfate. Polyionic salts such as polyphosphates, for example sodium hexametaphosphate or sodium tripolyphosphate, ammonium phosphates such as ammonium polyphosphate, polyacrylic acid salts such as sodium polyacrylate, polysulfide salts such as sodium polysulfide, and polysilicate salts such as sodium metasilicate can be added to the earth material for treatment. In some cases the salts above can be used as grinding agents for sizing particles of the earth material. Chloride salts such as magnesium, sodium, potassium, ammonium, aluminum, and iron chlorides can be used to selectively enhance metal separation, for example lithium, from thermally treated clays. Ammonium chloride, bifluoride, carbonate, and nitrate can be added to a clay material before or after thermal treatment to help dissolve metal, such as lithium, in the thermally treated clays so processes such as flotation can be used to recover said metal. Chelating agents such as citric acid, ethylenediaminetetraacetic acid (EDTA), diethylenetriaminepentaacetic acid (DTPA), nitrilotriacetic acid (NTA), and hydroxyethylethylenediaminetriacetic acid (HEDTA) can be added after thermal treatment of an earth material, optionally with organic alcohols (e.g. glycols) and acids and/or with extractive CO₂ (supercritical, near-critical, or sub-critical CO₂), to enhance recovery of metals such as lithium after thermal treatment of an earth material. The non-exclusive list of additives described above can be added as solids, liquids, or aerosols, and any combination of the above additives can be used for the various effects described.

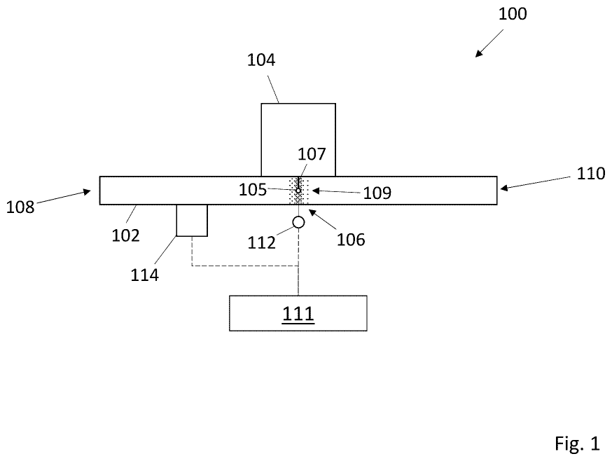

FIG. 1 is a schematic elevation view of a plasma activation apparatus 100 for an earth material. A container 102, which can be a conduit or a container for a non-flowing material, is juxtaposed with a plasma source 104. The plasma source 104 is configured to create a plasma 109 and to maintain the plasma 109 within a reaction space 106 in an interior of the container 102. The plasma source 104 is electrically coupled to a pair of electrodes 105 disposed within the reaction space 106 to create the plasma 109. Here, one electrode 105 is visible, with the other electrode obscured behind the visible electrode 105. An electrical conductor 107 couples the electrode 105 to the plasma source 104, and a similar conductor, which is not visible in FIG. 1, couples the obscured electrode to the plasma source 104. The electrodes 105 can be configured in any suitable manner or shape. For example, the electrodes 105 can be wires, plates, comblike or brushlike structures, straight or curved metal structures, and the like. The electrodes 105 define one or more gaps in which an electric discharge forms the plasma 109 within the reaction space 106. The gap has a dimension selected, along with power output of the plasma source 104, based on the properties of the materials to be introduced to the reaction space 106, such that the electric discharge can be maintained at suitable rates of material flow through the reaction space 106. The container 102 can be configured with an entrance 108 and exit 110 on opposite sides of the reaction space 106 so that material can be flowed continuously from the entrance 108, through the reaction space 106 to the exit 110 for a continuous activation process.

The earth material is transformed by exposure to the plasma 109 for a duration sufficient to cause rearrangement of aluminum, silicon, and oxygen atoms in the earth material to an alkali reactive configuration. The plasma creates Joule heating of the earth material within the plasma to momentarily heat the earth material to a temperature of at least about 700 K, and in some cases to 3,500 K or higher. The heating may be of a duration that results in flash Joule heating, for example if the heating duration is in the millisecond range. In addition to activating the earth material, it is believed that high temperature treatment of the earth material alters crystal structures of the earth material, resulting in increased mobility of metal ions within the earth material. Such increased mobility makes extraction of the metal ions from the earth material easier. A temperature sensor 112 may be coupled to the reaction space 106 to produce signals representing temperature within the reaction space 106. The signals can be used by a controller 111 to control various aspects of the activation process, such as material flow rate and plasma power. The controller 111 is typically a digital processing system that receives signals from sensors such as the temperature sensor 112, which may be analog or digital signals, and produces control signals for controlling aspects of the process being performed by the apparatus 100. The delivery of energy to accomplish the heating in a plasma method can be controlled by adjusting voltage and/or by using scalable power sources such as capacitor banks and multi-electrode assemblies

The apparatus 100 can include a preheater 114 coupled to the container 102 on an upstream side of the reaction space 106 to raise a temperature of the earth material flowing toward the reaction space 106 such that the plasma 109 will achieve a temperature target within the earth material. The signals from the temperature sensor 112 can be used by the controller 111 to control material flow rate through the reaction space 106, power supplied to the plasma 109, heat applied by the preheater 114, or any combination thereof, to maintain a target temperature within the reaction space. The treated earth material recovered from the plasma 109, for example exiting the exit 110 of the apparatus 100, can be used to form a geopolymer material or other alkali activated material. A geopolymer can be made using the activated earth material by dispersing the activated earth material in a high pH aqueous medium. The mixture forms a polymerization precursor that may be a slurry or a mud-like consistency. Dry polymerization precursors, which can include dry alkali activators and other dry additives, many of which are described below, can also be made using the treated earth materials. These methods allow recovery of a useful earth material after extraction of metals. The treated earth materials described herein can be used, before or after extraction of metals, for any application where cementitious materials are used. Such materials can replace conventional cement or concrete in all types of uses in oil fields, construction, and mining for example. It should be noted that such treatments of earth materials can also be used merely to create a residual material, after metals extraction, that can be solidified for easy handling and disposal. For example, as a residual material is recovered from metals extraction, a high pH aqueous solution can be mixed with the residual material to yield a solid by-product that can be easily handled.

The polymerization precursor typically has a “slurry density” that ranges from 0.84 g/cm3 (7 lbm/gal) to 2.87 g/cm3 (24 lbm/gal), such as 1.32 g/cm3 (11 lbm/gal) to 2.4 g/cm3 (20 lbm/gal) or 1.32 g/cm3 (11 lbm/gal) to 2.16 g/cm3 (18 lbm/gal), for example 1.36 g/cm3 (11.3 lbm/gal) to 1.90 g/cm3 (15.8 lbm/gal). The slurry density can be influenced by quantity of water added and/or by adding density modifiers. Water typically makes up from about 20% by weight to about 60% by weight of a polymerization precursor. Density modifiers can include density increasing particles and density lowering particles. Low-density particles may be added to the polymerization precursor mixture to achieve lower slurry densities for a given amount of water added, or heavy particles may be added to achieve higher slurry densities. The lightweight or low-density particles may have densities lower than 2 g/cm3, or lower than 1.3 g/cm3. Examples include hollow glass or ceramic microspheres (cenospheres), plastic particles such as polypropylene beads, rubber particles, uintaite (sold as GILSONITE™), bentonite, vitrified shale, petroleum coke or coal or combinations thereof. The lightweight particles may be present in the compositions at concentrations between about 0.06 kg/L and 0.6 kg/L (20 lb/bbl and 200 lb/bbl). The particle size range of the low-density particles may be between about 38 □m and 3350 □m (6 mesh and 400 mesh). The heavy particles typically may have densities exceeding 2 g/cm3, or more than 3 g/cm3. Examples include hematite, barite, ilmenite, crushed granite and also manganese tetroxide commercially available under the trade names of MicroMax™ and MicroMax FF™.

Reducing slurry density of the polymerization precursors described herein can make the precursors pumpable. Where solids volume fraction of the polymerization precursor is suitably low, such that the precursor produces a dial reading of less than 300 using a Cuvette viscometer equipped with an R1B1F1 rotor:bob:spring configuration, the polymerization precursor can be pumped to a target location without undue burden on pumping equipment, and the polymerization precursor can be polymerized at the target location. Such methods can be useful in a hydrocarbon production setting where a cement sheath is formed in a well to provide support for the well walls and isolation between segments of the well. Such methods can also be useful in other industries, such as construction and mining, where cementitious materials are used at locations other than the location at which the polymerization precursor is mixed.

Alkaline activators are typically added to the aqueous medium to create the high pH environment for polymerizing the treated earth materials. The alkaline activators used herein can be dry materials, to which water or a non-activating aqueous material is added. Examples include metal silicates M₂ₓSi_{y}O_{2y+x} where x is 1, 2, or 3 and y is 1 or 2 (for example silicates, metasilicates, orthosilicates, and pyrosilicates), where M can be Li, Na, K, Rb, or Cs, or combination thereof, for example a mixed metal silicate like a metal sodium silicate, alkaline earth metal hydroxides such as Ca(OH)₂, Sr(OH)₂, Mg(OH)₂ and/or Ba(OH)₂, alkaline earth metal oxides such as CaO, SrO, MgO and/or BaO, and alkaline earth metal peroxides such as MgO₂ and CaO₂ or a combination thereof. Such activators can be combined with an alkali metal salt such as a metal carbonate M₂CO₃, metal sulphate M₂SO₄, metal sulphite M₂SO₃, metal phosphate M₃PO₄, metal oxalate M₂C₂O₄, metal silicate M₂ₓSi_{y}O_{2y+x} where x is 1, 2, or 3 and y is 1 or 2 (for example silicates, metasilicates, orthosilicates, and pyrosilicates), metal fluoride MF, metal hexafluorosilicate M₂SiF₆, metal iodate MIO₃, metal molybdate M₂MoO₄, where M can be Li, Na, K, Rb, or Cs, or combination thereof, where such salts can have a combination of different metals and a combination of different anions. Lime and hydrated lime are examples of materials that contain calcium oxide and/or calcium hydroxide. Hydrogenated metal salts, such as MHCO₃, MHSO₄, MHPO₄, MHC₂O₄, M₂HPO₄, MH₂PO₄, and MHSO₃ can also be used, alone or in combination with other activators described herein, where M is as listed above. These activators can be added to the activated earth materials to form a dry blend. Upon addition of an aqueous medium, which can be simple water, the dry blend can be dispersed in the aqueous medium to form a high pH polymerization precursor that can subsequently be polymerized to form a geopolymer or another alkali activated material. The dry activators react with the water to raise the pH of the polymerization precursor such that the aluminum, oxygen, and silicon in the polymerization precursor dissolve and begin to react to form polymer. These activators are typically added in a quantity that is 2 to 40 parts per hundred based on the weight of the dry geopolymer precursor particulate blend, for example 4 to 20 parts per hundred or 4 to 40 parts per hundred based on the weight of the total dry geopolymer precursor particulate blend.

The alkaline activators used herein can also be aqueous solutions of the above materials and/or alkali metal hydroxides. Such alkaline activators can be added to the aqueous medium to be used for the geopolymer precursor before or after dispersing the reactant materials in the aqueous medium.

Properties of geopolymers, or other aluminosilicate polymers, made using plasma-activated earth materials can be adjusted using an assortment of additives. Thickening time of the polymerization precursors described herein can be influenced by adding retarders and accelerators. Several retarders may delay the setting and hardening of polymerization systems, for example by as much as 2 hours. Retarders such as sodium pentaborate decahydrate, borax, sucrose, boric acid, lignosulphonates, sodium glucoheptonate, tartaric acid, citric acid, or phosphorus containing compounds such as phosphoric acid, salts thereof (such as sodium phosphate and sodium hexametaphosphate), or mixtures thereof can be added to the polymerization precursor in amounts of 0.01 to 5 part per hundred by weight of the total polymerization precursor. Metal chlorides, in addition to facilitating recovery of metals from thermally treated earth materials, can also be accelerators and/or retarders.

The amount of retardation of the polymerization reaction, and the setting of the precursor, depends on the type of treated earth materials used for the precursor and the type and relative quantity of retarder used. Adding too much retarder reagent to a polymerization precursor described herein can cause the precursor to underpolymerize by interfering with the polymerization reaction so the polymerization precursor does not harden. In other embodiments a retarder solution can be added to the pumpable polymerization precursor such that the same precursor can be pumped to different target locations with different quantities of retarder enabling different setting times at different locations using the same precursor by adding different amounts of the retarder solution for the different locations. The polymerization precursors described herein, using retarders can add at least 2 hours to time to reach 70 Bc (Bearden consistency units) or 50 Bc using a pressurized consistometer.

Accelerators can also be added to the polymerization precursor particulate mixture in amounts up to about 0.01-10, such as 1-5, parts per hundred weight of the total particulate precursor mixture. The amount of acceleration of the polymerization reaction, and the setting of the slurry, depends on the type of raw materials used for the slurry and the type and relative quantity of accelerating reagent used. Adding too much accelerator to a polymerization precursor slurry can cause the slurry to thicken too quickly making it difficult to deploy the slurry to target locations downhole. It should be noted that the retarders and accelerants described herein can be included as particulate materials in the precursor composition, or such reagents can be added to water before the water is added to a precursor composition described herein.

In general, reactivity of the treated earth materials in an alkali-activated polymerization reaction can be modified or adjusted using salts or other inorganic materials, which can be added prior to thermal treatment or after thermal treatment. Materials such as borax, sodium phosphates, sodium carbonates, soda ash, and calcium oxide can be mixed with an earth material to form a mixture, and the mixture can then be thermally treated, optionally using plasma, microwaves, and/or other treatments, to form a precursor material having a targeted reactivity in alkali solution. Such materials can also be added after activation, and in some cases, a first portion of an additive can be added to the earth material prior to thermal treatment and a second portion of the additive can be added to the precursor material after thermal treatment. In general, additives that are sensitive to highly thermal environments are added after thermal treatment, while those that can withstand a highly thermal environment can be added before or after thermal treatment of an earth material.

Other additives, such as anti-foam agents, defoamers, fluid-loss control additives, viscosifiers, dispersants, expanding agents, anti-settling agents or combinations thereof, can be included in the polymerization precursor with the treated earth material. Selection of the type and amount of additive largely depends on the desired nature and composition of the aluminosilicate polymer, and those of ordinary skill in the art will understand how to select a suitable type and amount of additive for purposes herein. These additives may be added as dry materials with the treated earth materials to form a dry blend, which is mixed with the aqueous medium to form the polymerization precursor, or the additives may be added to the aqueous medium prior to mixing with the treated earth materials.

The fluid-loss control agent may comprise a latex. The latex may be an alkali-swellable latex. The latex may be present in the polymerization precursor at a concentration between 0.02 L/L and 0.3 L/L or between 0.05 L/L and 0.15 L/L.

Viscosifiers may comprise diutan gum having a molecular weight higher than about 1×106. The diutan gum may be present in the polymerization precursor at a concentration between 0.14 g/L and 1.4 g/L (0.05 lbm/bbl and 0.5 lbm/bbl). In some cases, viscosifiers are present in the polymerization precursor at a concentration of 0.1-5% by weight. Other viscosifiers may comprise a polysaccharide material, which may be a biopolymer. Suitable polysaccharide biopolymers can include welan gum, a polyanionic cellulose (PAC), a carboxymethylcellulose (CMC), and combinations thereof. One or more polysaccharide materials, which may be biopolymers, may be present in the polymerization precursor at a concentration between 0.14 g/L and 1.4 g/L (0.05 lbm/bbl and 0.5 lbm/bbl). The molecular weight of the polysaccharide material, which may be a biopolymer, may be between 100,000 and 1,000,000.

Carboxylic acids including gluconic acid and soluble salts thereof, glucoheptonic acid and soluble salts thereof, tartaric acid and soluble salts thereof, citric acid and soluble salts thereof, glycolic acid and soluble salts thereof, lactic acid and soluble salts thereof, formic acid and soluble salts thereof, acetic acid and soluble salts thereof, proprionic acid and soluble salts thereof, oxalic acid and soluble salts thereof, malonic acid and soluble salts thereof, succinic acid and soluble salts thereof, adipic acid and soluble salts thereof, malic acid and soluble salts thereof, nicotinic acid and soluble salts thereof, benzoic acid and soluble salts thereof, and ethylenediamine tetraacetic acid (EDTA) and soluble salts thereof may be included in the polymerization precursor as retarders or dispersants or both. Phosphoric acids may be present for the same purpose. Salts of these acids may also be employed. These materials may be present in the compositions at concentrations between 0.5 g/L and 10 g/L, or between 1 g/L and 5 g/L.

Expanding agents may comprise calcium sulfate hemihydrate, metal oxides such as MgO or combinations thereof. The expanding agents may be present in the polymerization precursor at concentrations between 0.01 kg/L and 0.2 kg/L of slurry, or between 0.05 and 0.1 kg/L.

Where the earth materials contain elements of interest other than aluminum, silicon, and oxygen, for example metals that may be valuable, the thermal treatment processes described herein can enable or facilitate recovery of such elements using direct aqueous extraction processes. Metal ions can be leached from the treated earth materials to form an aqueous ion source that can then be processed to recover the elements of interest. Elements such as lithium, nickel, cobalt, manganese, copper, germanium, boron, uranium, aluminum, potassium, iron, zinc, titanium, and the like can be recovered by leaching from thermally treated earth materials and extraction from an aqueous medium. In some cases, such elements can be leached from the earth material prior to thermal treatment. In other cases, thermal treatment and leaching can be repeatedly performed on an earth material to maximize recovery of elements of interest from the earth material.

For example, an earth material can be subjected to a first leaching operation to form a first dilute metal ion solution. The earth material can then be subjected to plasma treatment, or other thermal treatment, to form a treated earth material. The treated earth material can then be subjected to a second leaching operation to form a second dilute metal ion solution. The first and second dilute metal ion solutions can be combined for further processing. The treated earth material can, itself, be subjected to additional thermal treatment, for example a second plasma treatment, to increase the activation of the earth material.

In some cases, an earth material can be subjected to a pretreatment to remove unwanted materials prior to thermal treatment. For example, an earth material can be contacted with a fluid, prior to plasma treatment, selected to remove unwanted salts, metals, organic materials, and the like, prior to plasma treatment. More than one such treatment can be performed, if necessary, optionally using different fluids for the different treatments. For example, if water-soluble and water-insoluble materials need to be removed, a first treatment can use water to remove unwanted water-soluble materials (such as sodium, magnesium, and calcium chlorides), and then a second treatment can use an organic solvent to remove any organic materials.

During thermal treatment of the earth material that has been subjected to a leaching operation, the earth material can be thermally treated while some leaching fluid remains in the earth material. The leaching fluid that remains in the earth material vaporizes quickly, for example during a plasma treatment. In some cases, the leaching fluid flashes into vapor during the plasma treatment. The flashing of vapor within particles of the earth material, along with the elevated temperature, can facilitate rearrangement of the aluminum, silicon, and oxygen atoms within the earth material to form the alkaline-reactive configuration. Such plasma treatment operations can be called flash calcination of the earth materials. Thus, an earth material can be subjected to repeated plasma treatment, which may include plasma flash calcination, alternating with leaching treatment to form an activated earth material and a dilute metal ion solution.

Generally, the earth material is exposed to a leaching fluid and aggressively mixed, for example by milling the mixture of the earth material or the activated earth material and the leaching fluid, to cause one or more elements of interest, for example lithium, from the earth material to move into the leaching fluid. The leaching fluid is generally an organic solvent with relatively high vapor pressure, such as a low-boiling alcohol, or an aqueous material having pH less than about 9. The leaching fluid may be selected to have minimal impact on polymerizability of aluminum, silicon, and oxygen in the earth material so that, in some cases, the earth material can subsequently be used as a precursor for forming an alkali-activated aluminosilicate polymer. Examples of organic leaching fluids that can be used include methanol, ethanol, 1-butanol, 2-butanol, 1-propanol, 2-propanol, formic acid, N-methylformamide, hydrazine, tetrahydrofuran, a beta-diketones, an organophosphorus compound, a crown ether, lithium bis(trifluoromethanesulfonyl)imide, 1-butyl-3-methyl-imidazolium hexafluorophosphate, tetrabutylammonium mono-2-ethylhexyl-(2-ethylhexyl) phosphonate, tetrabutylammonium bis(2-ethylhexyl)phosphate, tetrabutylammonium bis(2-ethylhexyl)phosphinate, tetrabutylammonium diisooctylphosphinate, N-butyl pyridinium bis((trifluoromethyl)sulfonyl)imide, or a combination thereof. Such materials may have selectivity for certain elements, such as lithium. Acids, such as sulfuric or hydrochloric acid, can be used for leaching, and brines such as sodium or magnesium rich brines can also be used to leach certain clays. Extractive CO₂ can also be used to leach metals from an earth material, whether treated or not.

To extract metal ions leached from the earth material or treated earth material, a dilute metal ion solution formed during the leaching process is subjected to a direct extraction process. The dilute metal ion solution is an aqueous solution containing metal ions leached from the earth materials. During leaching, the leaching fluid contacts the earth material and withdraws metal ions from the earth material to form a loaded leaching fluid. The leaching fluid may be selective for one or more metal ions, and where a selective leaching fluid is used, a greater proportion of one metal ion may be withdrawn from the earth material than another metal ion.

Where the loaded leaching fluid is non-aqueous, the loaded leaching fluid is then contacted with an aqueous medium to transport the metal ion or metal ions from the loaded leaching fluid into the aqueous medium to form the dilute metal ion solution. In some cases, an organic leaching fluid may be incompatible with materials used for the direct extraction process. In such cases, the process of transporting the metal ion from the loaded leaching fluid to the aqueous medium is configured to minimize leaching fluid becoming dissolved in the dilute metal ion solution. The aqueous medium may be configured such that the leaching fluid is chemically incompatible with the aqueous medium. For example, the aqueous medium may be selected such that the leaching fluid is immiscible with the aqueous medium. In such cases, the aqueous medium is contacted with the loaded leaching fluid by mixing to an extent that provides a desired transportation of metal ions from the loaded leaching fluid to the aqueous medium. In some cases, the aqueous medium may be a brine or a dilute brine that contains a salt of the metal ion or ions to be transported from the loaded leaching fluid. Inclusion of the salt in the aqueous medium may reduce miscibility of the organic leaching fluid with the aqueous medium. Energetic mixing of the aqueous medium with the loaded leaching fluid can then form small liquid domains with high contact surface area to provide high diffusion area and low diffusion distances to maximize ion transportation. Where the leaching fluid is a suitable aqueous material, such as a suitable brine or acid, the loaded leaching fluid may be directly passed to direct extraction without further processing in some cases.

The apparatus 100 can be substantially mobile so that the apparatus 100 can be located near a source of earth material or near a point of use of the earth material. For example, the apparatus 100 can be co-located with a well cementing facility to produce activated earth materials to be formed into a polymerization precursor for use in cementing the well. The apparatus 100 can also be co-located with a facility to recover elements of interest from the earth material, before or after activation, as described further below.

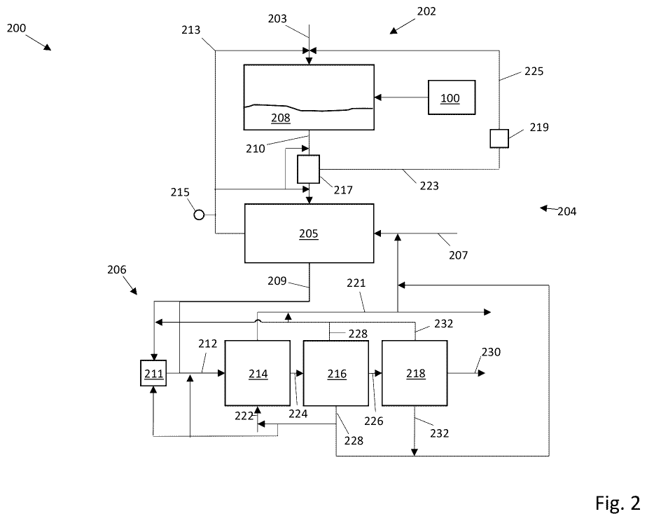

FIG. 2 is a schematic process-flow diagram of a metal recovery process 200 according to one embodiment. The metal recovery process 200 includes a leaching process 202, a leaching fluid separation process 204, and a selective recovery process 206. In the leaching process 202, an organic leaching fluid 203 is contacted with an earth material 208 to yield a loaded leaching fluid 210, as described above. The earth material 208 can be an earth material treated using the apparatus 100. Any of the fluids described above can be used, and the earth material can be a plasma-treated earth material. The loaded leaching fluid 210 includes a metal ion, or multiple metal ions, leached from the earth material 208 into the leaching fluid 203.

Where the earth material is treated using the apparatus 100, metal ions in the earth material are made more accessible to extraction by processes such as leaching. In some cases, metal can be vaporized during treatment using the apparatus 100. In such cases, free metal ions separate from the earth material and can agglomerate and cool to form solid metal particles within the treated earth material. For example, where an earth material contains a low concentration of metal ions, or where metal ions are highly conductive or have low vaporization temperatures, the metal ions may be partially or fully vaporized upon treatment of the earth material. If desired, prior to leaching or other processing, such metal particles can be recovered using any suitable separation process. Flotation and gravity separation are examples of processes that can be used to separate free metal liberated by thermal treatment of an earth material. Any of the metals mentioned herein can be vaporized during thermal treatment of an earth material and then recovered thereafter, at least in part, using such methods.

The loaded leaching fluid 210 is routed to the leaching fluid separation process 206, where the metal ion or ions is substantially removed from the loaded leaching fluid 210 in a separator 205. An aqueous fluid 207 is provided to the separator 205 and intimately mixed with the loaded leaching fluid 210 to transport the metal ion or ions from the loaded leaching fluid 210 into the aqueous fluid 207 to form a dilute metal ion solution 209 containing the leached metal ion or ions. The dilute metal ion solution 209 is routed to the selective recovery process 206 for recovery of the metal ion or ions.

In the leaching process 202, the earth material 208 is generally contacted with the leaching fluid 203 and mixed in a way that promotes intimate contact between individual particles of the earth material and the aqueous medium. The mixing can be performed in a vessel by static or dynamic mixing methods that can use any combination of flow structures, agitators, impellers, jet mixers, and the like to maximize mixing of solid and liquid components. In some cases, the leaching can be performed in more than one contacting stage to increase leaching performance.

The selective recovery process 204 generally has an extraction stage 214, a purification stage 216, and an optional conversion stage 218. The dilute metal ion solution 209 is provided to the extraction stage 214, or to a pretreatment 211 to extract metal ions of interest from the dilute metal ion solution 209. The pretreatment 211 can include processes to condition materials to be provided to the extraction stage 214 as needed and as required and/or defined by the source of the materials. For example, where a source includes particular impurities, such as organic materials, that may be unhelpful for downstream processing, the pretreatment 211 can include processes for removing such impurities. The pretreatment 211 can include processes for removing particulate impurities, ions, organisms, organic solvents, or any other impurities. Such processes can include, for example, gravity separation, gas flotation, filtering such as membrane filtering, inducing coalescence, adsorption/desorption, and bacterial or microbial processing. The pretreatment 211 can also include processes for adjusting composition of one or more streams to be provided to the extraction stage 214, such as concentration, pH adjustment, total dissolved solids, ion ratios, and the like. The pretreatment 211 can also add processing aids, and can adjust other parameters, such as temperature.

In the extraction stage 214, an extraction stage feed 212, obtained from the leaching fluid separation process 206 or from the pretreatment 211, is subjected to direct extraction to extract the metal ion or metal ions from the extraction stage feed 212. The direct extraction may be a sorption-desorption process, an evaporation process, an ion-exchange process, an electrochemical process, or any other suitable process for extracting metal ions.

In a sorption-desorption process, the extraction stage feed 212 is contacted with a withdrawal material to remove target metal ions from the extraction stage feed 212. The withdrawal material can be solid or liquid, and is typically selective for the target metal ions. Contacting the extraction stage feed 212 with the withdrawal material results in a loaded withdrawal material and a depleted aqueous material 221. The depleted aqueous material 221 can be returned to the environment as a reject stream, and may be purified or have its pH adjusted before being returned to the environment. The depleted aqueous material 221 can also be used in the leaching fluid separation process 206 combined with the aqueous fluid 207.

The withdrawal material may be configured in a fixed bed, fluidized bed, or partially fluidized bed configuration. In some cases, the extraction stage 214 can be configured as a plurality of extraction operations that can be arranged in a suitable way. For example, in some cases the plurality of extraction operations can be arranged in a counter-flow arrangement described further below.

In the leaching fluid separation process 206, leaching fluid depleted of metal ions can be recycled to the leaching process 202 in a leaching fluid recycle 213, which can be mixed with the leaching fluid 203 to perform further leaching and to minimize use of organic leaching fluids. A composition sensor 215 can be coupled to the leaching fluid recycle 213 to monitor composition of the leaching fluid recycle 213. Where, for example, the target metal ions are not fully removed from the leaching fluid during the leaching fluid separation process 206, target metal ions can build up in the leaching fluid recycle 213. The composition sensor 215 can detect buildup of target metal ions in the leaching fluid recycle 213 and readings from the composition sensor 215 can be used to trigger remedial action in the event content of target metal ions, or any other species, in the leaching fluid recycle, reaches a tolerance level. In one case, where content of target metal ions in the leaching fluid recycle 213 reaches a tolerance level, as detected by the composition sensor 215, the leaching fluid recycle 213 can be diverted back to the leaching fluid separation process 206 for additional metal ion separation. In other cases, the leaching fluid recycle 213 can be purged or subjected to additional processing of a suitable nature.

The leaching fluid separation process 206 can use a heater 217 to vaporize a portion of the organic leaching fluid in the loaded leaching fluid 210 prior to contacting the loaded leaching fluid 210 with the aqueous stream 207 in the separator 205. A vaporized organic leaching fluid 223 is removed from the heater 217, and can be returned to the leaching process 202 for mixing with the leaching fluid 203. The vaporized organic leaching fluid 223 can be condensed, if needed, using a condenser 219, so that a removed leaching fluid 225 can be returned to the leaching process 202. Where a heater is used, the remainder of the loaded leaching fluid 210 is forwarded to the separator 205 having an increased concentration of the metal ion or ions. Routing less leaching fluid to the separator 205 can allow for a smaller separator 205 and may improve transport of metal ions from the organic to the aqueous phase in the separator 205.

Where a sorption-desorption process is used, after metals are withdrawn by the withdrawal material, the withdrawal material is in a state of being loaded with metal ions, at least to an extent. In many cases, metal withdrawal may be continued until the withdrawal material reaches an end point, which can be a point at which the withdrawal material can withdraw no more metal ions, or at a selected point prior thereto. In such cases, an eluent 222 is used to unload the metal ions from the withdrawal material. The eluent 222 is an aqueous stream that may be water, a brine solution, an acidic solution, an acidic brine solution, a buffer solution, or another material selected to remove the metal from the withdrawal material. The eluent 222 may be selective to the metal ion or ions in the withdrawal material so that impurity materials elute to a lesser extent than elements of interest. In most cases, the eluent 222 will be water or brine, and may be sourced from other units of the extraction process 204. In some cases, a sorption-desorption process is selected as the extraction process because aqueous streams from other parts of the process can be captured and integrated with the extraction process as eluent or other uses.

Removing metals from the withdrawal material in the extraction stage 214 yields an extract 224 that may be routed to the purification stage 216. In the purification stage 216, the concentration of elements of interest is typically increased and the concentration of any impurities is reduced, or at least increased by a proportion less than that of the elements of interest. In some versions, the purification stage can remove some divalent species, such as calcium and magnesium, by exchanging for sodium. In such cases, the calcium and magnesium typically precipitate and are removed using solids removal processes.

The purification stage 216 can include any mixture of filtration processes, osmotic processes, evaporation processes, redox processes (including electrochemical processes), and solids removal processes to remove water and impurities from the extract 224. The purification stage 216 may also include concentration (to increase the total dissolved solids in the stream and remove water), using membrane separation processes, such as reverse osmosis or osmotically assisted reverse osmosis, or evaporation. In an embodiment, a concentration stage includes several reverse osmosis units in series to increase the TDS of the stream gradually, for instance a reverse osmosis unit in series with one or more of osmotically assisted reverse osmosis units. The reverse osmosis units may include a membrane selective for the metal ion. A concentrate 226 is produced by the purification stage 216 along with one or more removed streams 228. The removed streams 228 are generally aqueous streams that can have some elements of interest, such as lithium or cobalt along with elevated levels of impurities such as sodium, potassium, calcium, and magnesium. The removed streams 228 can be returned, in part or in full, to the extraction stage 214 to recover any elements of interest. Depending on the concentration of impurities and elements of interest in the removed streams 228, all or part of the removed streams 228 can be used as, or included in, the eluent 222. Additionally or instead, all or part of the removed streams 228 can be mixed with the extraction stage feed 212 or sent to pretreatment 211 to re-process the removed streams 228 in the extraction stage 114. Additionally, or instead, all or part of the removed streams 228 can be used with the aqueous stream 207 to separate metal ions in the separator 205 of the separation process 206.

The concentrate 226 can be routed to the conversion stage 218 where elements of interest can be converted to different forms, if desired. For example, lithium chloride can be converted to lithium hydroxide monohydrate by treatment with sodium hydroxide, or to lithium carbonate by treatment with sodium carbonate, or both, in the conversion stage 218. The conversion stage 218 which may include processes to maximize concentration of elements of interest, before and/or after conversion, produces a product 230, which may be, for example, hydroxide, carbonate, or both, and an aqueous byproduct 232 that is usually mostly water and displaced ions such as chloride and sodium, but may include some unreacted ions from the conversion such as hydroxide and carbonate ions. The aqueous byproduct 232 can be routed to disposal or re-used in various ways in the process 200. For example, where elements of interest are separated into the byproduct 232, the byproduct can be routed to the purification stage 216 or to the extraction stage 214 to recover the elements of interest. Where the byproduct 232 contains unreacted anions, those can be neutralized, if necessary, by appropriate treatments (HCl to neutralize OH⁻ or make CO₂ from carbonate; CaCl₂ to precipitate CO₃²⁻, etc). Unreacted anions can also be recycled internally within the conversion stage 218. The byproduct 232 can also be used to adjust pH of the dilute metal ion solution 210 from the separation process 206.

In a case where the element of interest is lithium, lithium from the leaching process 202 is recovered to the dilute metal ion solution 209 in the separation process 206 and routed to the extraction process 204 for recovery, where a lithium-selective recovery process is used to recover the lithium. The dilute metal ion solution 209, in this case a dilute lithium solution, is usually added to the extraction stage 214. In some cases, for example where impurity content of the dilute lithium solution is low, the dilute lithium solution may be added directly to the purification stage 216. In other cases, the dilute lithium solution could be subjected to an independent concentration operation to increase lithium content so a resulting concentrated lithium solution from the separation process 206 could be added directly to the purification stage 216 without diluting lithium content of any streams of the purification stage 216.

The aqueous stream 207 for the separation process 206 can be sourced, entirely or in part, from the extraction process 204. Many of the streams separated in the extraction process 204 are low in concentration of elements of interest and relatively higher in concentration of impurities. Such streams can be highly selective solvents for elements of interest, compared to other impurities such as alkali metals and alkaline earth metals, because with a base load of impurity ions, the capacity of such streams to dissolve additional impurity ions is reduced. Thus, any or all of the depleted material 221, the removed stream 228, and the byproduct 232 can be used to absorb elements of interest from the loaded leaching fluid 210 in the separator 205 to form the dilute metal ion solution 210, which is returned to the extraction process 204. The streams 221, 228, and 232 can be blended in any convenient proportion, and can be supplemented with other aqueous materials, such as water, salt solutions, acid solutions, or salt-acid solutions to achieve any optimal recovery fluid for the separator 205. The streams 221, 228, and 232 can also be used to adjust temperature, pH, total dissolved solids, or other parameters for the separation process 206. Temperature of the aqueous fluid for the separator 205 can also be adjusted to optimize transport of metal ions.

A control system can manage the compositional balance of the process 200 to achieve the most efficient and effective recovery of elements of interest. Ion analyzers, pH analyzers, conductivity analyzers, density analyzers, elution analyzers, and the like can be used to output signals representing properties of various streams of the process 200, and a controller can be configured to adjust parameters of the streams, such as flow rates and temperatures, to manage operation of the stages of the extraction process 204. The control system can use any convenient model, expert system, machine learning system, or the like to determine targets for the processes 202, 204, and 206 based on known techniques for controlling manufacturing processes.

The control system can also be configured to maintain water balance of the processes 202, 204, and 206. Careful use, separation, and re-use of aqueous streams is typically effective to minimize or prevent incremental handling of water. Water enters the process 200 as the aqueous material 207, the stripping material 122, and potentially with the earth material 208. Water can leave the process 200 through any of the depleted material 221, the removed stream 228, the byproduct stream 232, and the product 230, or at other locations. The controller can be configured to monitor the trend of the water balance using the flow rates and compositions of these streams.

The earth material 208 can add a wide variety of impurity metals to the process 200. For example, metals such as iron, silver, gold, copper, and tin are found in various clays in diverse amounts. Organic materials can also be found in earth materials, and small amounts of organic leaching fluid can pass through the separation process 206. Particulate solids can also be fluidized and entrained with the loaded leaching fluid 210 and the dilute metal ion solution 209. Such impurities can be removed by known treatments that can include filtration using various media such as activated carbon, magnesium dioxide, and resin media. Other impurities, including metals and various anions, can be removed using filtration methods such as membrane filtration, reverse osmosis, dialysis processes, and the like. A staged filtration process, with at least some recycling of reject streams, can help increase separation efficiency between lithium and impurity materials.

The extraction process 204 can use the pretreatment 211 to condition streams for extraction in the extraction stage 214. The pretreatment 211 can adjust composition of streams, for example reducing impurities, increasing concentration of elements of interest, and/or adjusting pH, to optimize or otherwise facilitate processing in the extraction stage 214. The pretreatment 211 is optional, and may be included in a way that permits bypassing the pretreatment 211, or using the pretreatment 211, for every stream that can be provided to the extraction stage 214. Thus, any or all of the dilute metal solution 209, the removed stream 228, and the byproduct stream 232 can provided to the pretreatment 211. In particular, the pretreatment 211 can be used to remove any trace organics that might be leached from the earth material 208 or pass through the separation process 206 into the dilute metal ion solution 209. The pretreatment 211 can also be used to remove any other trace impurities that might not be removed or adequately reduced in concentration in the purification stage 216.

Finally, it should be noted that any of the aqueous streams output from the extraction process 214 could be used as the aqueous medium to form the polymerization precursor referred to in connection with the apparatus 100. Thus, the process 200 can be at least partially integrated with the polymerization process to reuse aqueous streams efficiently. Where the aqueous streams can include alkali metal salts such as lithium chloride and sodium chloride, those salts may serve useful purposes as additives in the polymerization precursor, potentially relieving the need for some additional additives.

As mentioned above, earth materials can be treated using microwaves. In addition to potentially activating such materials for use in alkali activated polymerization processes, such treatment can facilitate recovery of metals from the earth materials. Treatment of earth materials using microwaves can alter the morphology of metal-containing particles within the earth material to simplify recovery of valuable metals such as lithium, aluminum, and magnesium from the earth material. Microwaves can couple strongly with polar molecules such as water and alcohols, and in some cases with components of the earth materials themselves. Thus, an earth material can optionally be mixed with a polar liquid to form a solid-liquid mixture such as a mud, paste, or slurry that can then be treated using microwaves to accomplish a beneficiation process that makes metal recovery easier. The material separated from the metals in recovering the metals is typically then suitable for use in an alkali activated polymerization process to make a cementitious material.

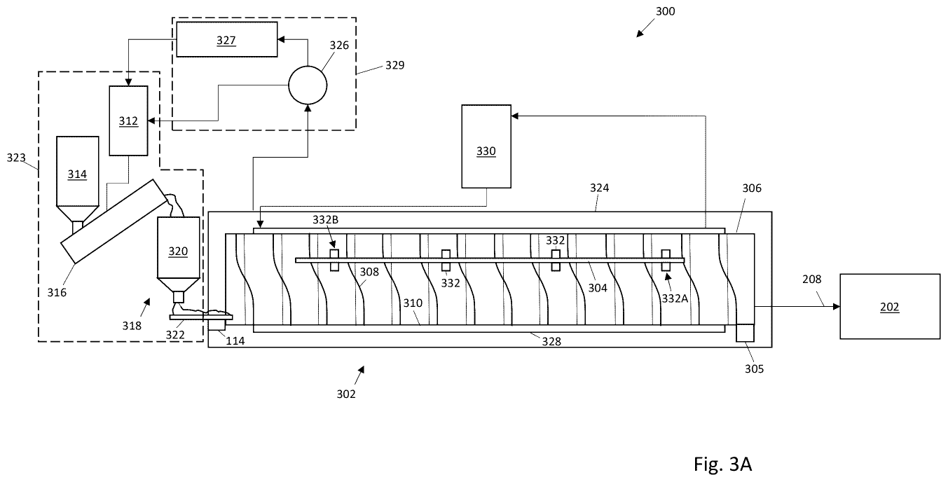

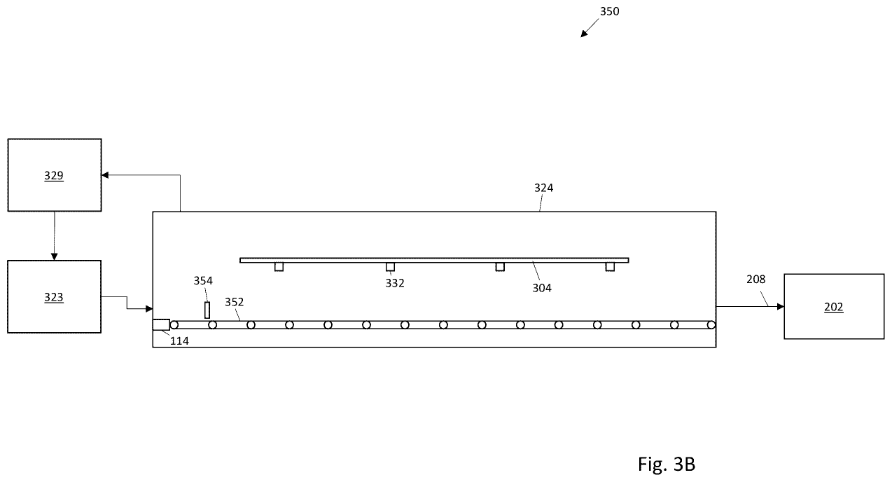

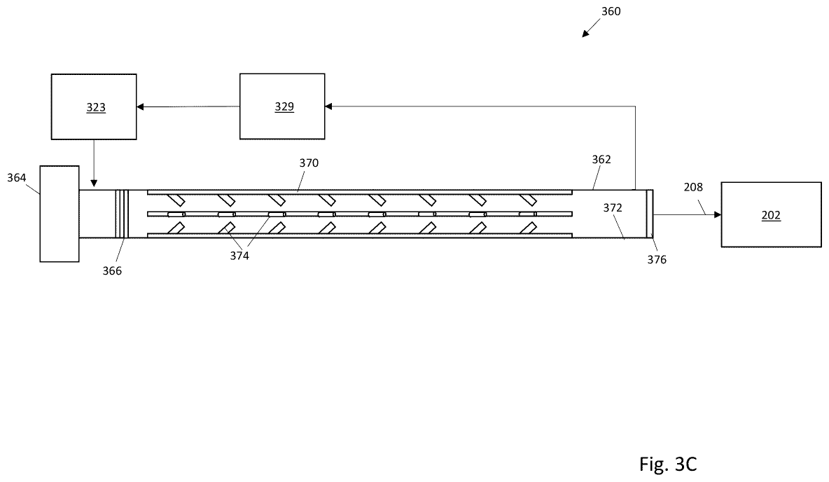

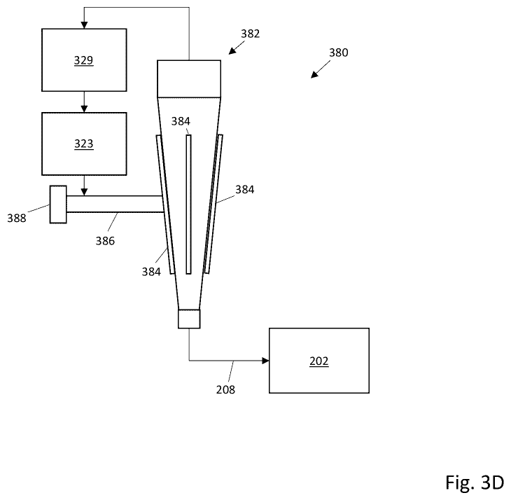

A continuous flow microwave apparatus can be used to treat an earth material using microwaves. FIG. 3A is a schematic side view of a continuous flow microwave treatment apparatus 300 for treating earth materials according to one embodiment. The apparatus 300 has a rotary drum processor 302 that has a microwave source 304 disposed in an interior of the rotary drum processor 302. The rotary drum processor 302 has a cylindrical outer wall member 306 and a helical flow guide 308 attached to an inner wall 310 of the outer wall member 306. A rotary actuator 305 is coupled to the wall member 306 to provide rotational motion about the cylindrical axis of the wall member 306. The rotary actuator 305, in this case, contacts an outer surface of the wall member 306 to rotate the wall member 306. Precession of the helical flow guide 308, along with the action of gravity, moves material through the rotary drum processor 302 in an axial direction. In this case, a continuous helical flow guide provides continuous flow impetus as the feeder 302 rotates, but in other cases, the flow guide 308 can be discontinuous in a helical, quasi-helical, or non-helical pattern. In another example, a series of ring-shaped shelves, ridges, or protrusions, can be used as the flow guide 308. Here, the rotary drum processor 302 is oriented horizontally, but in other cases, the rotary drum processor 302 could be tilted upward or downward to influence flow characteristics within the feeder 302. Axial flow guides, such as shelves, ridges, or protrusions extending along the inner wall of the outer wall member 306 in the axial direction of the rotary drum processor 302, can also be used. A plurality of distributed bumps along the interior wall of the outer wall member 306 can also be used as a flow guide.

Different flow guides can have different flow and mixing characteristics. A helical screw flow guide generally provides mixing that can be selected and/or controlled by varying rotation rate and by selecting screw pitch, feeding patterns, and/or tilt angle. The mixing, using a helical flow guide, occurs by a combination of folding, circumferential, and axial motion. A ring-like flow guide can mix by folding and circumferential motion, but more axial motion can be caused by tilting the wall member 306. Axial ridges will also mix the material mainly by folding. Distributed inner bumps will cause axial, circumferential, and radial motion while rotation of the feeder causes folding motion. Combinations of different types of flow guides can be used.

The microwave source 304 is disposed in the interior of the rotary drum processor 302 to project microwave radiation toward a material moving through the rotary drum processor 302. The microwave source 304 can be, or can include, one or more microwave horns as discrete microwave sources. Alternately, the microwave source 304 can be a continuous microwave emitter disposed along an axial direction of the rotary drum processor 302. The microwave source 304 is oriented to emit microwaves toward the material moving within the wall member 306, as the wall member 306 is rotated, to increase a temperature of the material progressively as the material is moved through the rotary drum processor 302. A single power supply can power all microwave emitters in the microwave source 304, or where multiple discrete emitters are used, multiple power supplies, for example one power supply for each emitter, can be used. Use of multiple emitters for the microwave source 304 can allow control of the microwave energy emitted by each emitter so that microwave energy can be emitted at different power levels, different frequencies, or both, if desired.

Microwaves couple with materials having suitable dielectric properties. Thus, the microwave radiation to be used can be selected based on the material dielectric properties. As mentioned above, a polar liquid can be mixed with an earth material having metal-containing clays, and the mixture treated using microwaves, to simplify recovery of the metals from the clays. The clay particles of the earth material are preferentially moistened by the polar liquid, giving rise to enhanced microwave susceptibility for the metal-containing clay particles versus other particles, such as sand and silica, that might be present in the earth material. Use of a polar liquid can thus enhance selectivity of the microwave treatment for the metal-containing components of the earth material. The polar liquid can be water, a low-boiling solvent such as methanol, ethanol, butanol, propanol, ethylene glycol, acetone, acetic acid, acetonitrile, dimethylformamide, ethyl acetate, pyridine, and other similar materials.

The polar liquid can be mixed with the earth material prior to providing the mixture to the rotary drum feeder 302. The polar liquid can be provided from a polar liquid source 312, which may contain one or more polar liquids stored as a mixture or stored separately. The earth material may be provided from an earth material storage unit 314 to a mixing unit 316, which may be a screw feeder or other device. The polar liquid is also provided to the mixing unit 316 where the polar liquid and the earth material are mixed. The mixture is then provided to the rotary drum feeder 302. In this case, the mixture is disposed in a feed unit 318 that provides the mixture to the rotary drum feeder 302. The feed unit 318 may include a hopper 320 to control flow of the mixture to the feeder 302. The hopper 320 may deposit the mixture at a controlled rate onto a conveyor 322, or other movement unit, to deliver the mixture to the rotary drum feeder 302. The earth material source 314, polar liquid source 312, mixing unit 316, feed unit 318, and conveyor 322 form a feed preparation unit 323 that provides material to the rotary drum feeder 302.

The earth material is mixed with a quantity of the polar liquid that is sufficient to moisten the particles of the earth material while avoiding significant agglomeration of the particles. If, in some cases, the particles become too wet, the mixture of earth material and polar liquid can be dried using any suitable method prior to providing the mixture to the rotary drum feeder 302.

The microwave energy is typically configured to raise a temperature of the earth material being treated to at least about 600 K, such as 600 K to 800 K, for example 700 K. If variable frequency emitters are used, the microwave frequency can be varied to match absorption characteristics of the earth material, at constant power input and flow rate of material through the microwave treatment apparatus 300, until a maximum is reached in temperature of the earth material. If that temperature is higher than needed, or higher than a target temperature, or higher than a tolerance temperature, the power input to the microwave source can be reduced, and if that temperature is lower than needed, or lower than a target temperature, or lower than a tolerance temperature, the power input to the microwave source can be increased.

The polar liquid mixed with the earth material may vaporize during the treatment. The wall member 306 may be disposed within an enclosure 324 to capture vapor evaporating from the mixture during the microwave exposure. The vapor may be recovered from the enclosure 324 and processed for return to the polar liquid source 312 in a recycle system 329. The recycle system 329 may include a condenser 326 to condense the vaporized and collected polar liquid. The condensed vapor may be routed directly back to the polar liquid source 312 for reuse. Other processes may be performed on the collected vapor or the condensed vapor, as needed, to prepare the collected and/or condensed vapor for reuse. Optionally, for example, the recycle system 329 can include a purification unit 327 to remove any impurities in the condensed polar liquid acquired from contact with the earth material. The purification unit 327 can include any suitable processes, such as filtration, settling, distillation, and the like for removing or separating mixed, dissolved, or undissolved impurities.

Microwave processing increases a temperature of the earth materials, optionally mixed with polar liquid, within the rotary drum processor 302. The outer wall member 306 may be thermally controlled to avoid any negative effects of excessive temperature on the outer wall member 306. For example, a jacket 328 can be provided around all or part of the outer wall member 306 to provide a pathway to circulate a thermal control medium along the outer surface of the outer wall member 306. The thermal control medium can be stored in a vessel 330 and circulated through the jacket 328 to maintain thermal control of the outer wall member 306. If necessary, the thermal control medium can be maintained at a target temperature in the vessel 330 using a thermal control system. A rotary seal can be disposed between the jacket 328 and the outer surface of the outer wall member 306 to retain the thermal control medium within the jacket 328. Any thermal control medium that leaks through the rotary seal may be collected and returned to the vessel 330. A collection system (not shown) can be located within the enclosure 324 to collect any leakage at the rotary seal.

The microwave source 304 can be configured to deliver a constant radiant dose of microwave energy along the length of the microwave source 304, or the microwave source 304 can be configured to deliver different radiant doses at different locations. For example, the microwave source 304 may have a plurality of emitters that are separately controlled to deliver independent frequency and power output of microwave energy such that the earth material moving through the rotary drum processor 302 experiences different microwave exposure at different locations. Thermal sensors 332 can be disposed within the rotary drum processor 302 to monitor thermal state of the earth material mixture at different locations within the processor 302. Output of the thermal sensors 332 can be used to control heating of the earth material, for example by adjusting power output, frequency, or both, of one or more of the emitters of the microwave source 304.

The thermal sensors 332 can be in two groups. A first plurality 332A of thermal sensors can be oriented to sense the thermal state of the earth material, while a second plurality 332B of thermal sensors can be oriented to sense a thermal state of the outer wall member 306. As described above, the first plurality 332A of thermal sensors can be used to sense and optionally control the thermal state of the earth material, optionally mixed with polar fluid, at different locations within the rotary drum processor 302. The signals from the first plurality 332A can be used to control the heat history of the earth material mixture by independently adjusting operation of microwave emitters of the microwave source 302 such that the earth material mixture reaches a desired temperature and/or is exposed to a desired thermal history. Heat history of the earth material mixture can also be adjusted and/or controlled by adjusting flow rate, and thus residence time, of the earth material mixture in the rotary drum processor 302. Flow rate of the earth material mixture can be adjusted by changing rotation rate of the rotary drum processor 302 using output of the rotary actuator 305.

The second plurality 332B of thermal sensors can be used to sense and optionally control the thermal state of the outer wall member 306 so that any temperature excursions do not have excessive effect on the outer wall member 306. The thermal state of the outer wall member 306 can be controlled, based on signals from the second plurality 332B, by adjusting flow rate and/or temperature of the thermal control medium flowing through the jacket 328. Excessive wear on the outer wall member 306 can be avoided.

The microwave processing apparatus 300 outputs an earth material 208 that has been treated using microwaves to prepare the earth material for extraction of valuable materials. The earth material 208 can then be provided to the leaching process 202. It should be noted that, in some cases, the polar liquid used to treat the earth material in the microwave apparatus 300 may be the same liquid as the leaching fluid 203, so that, if the microwave apparatus 300 is co-located with the leaching process 202, leaching fluid recovery process 204, and selective recovery process 206, the leaching fluid 203 can be stored in a vessel like the vessel 312 and used for both leaching and microwave treatment.

FIG. 3B is a schematic side view of a continuous flow microwave treatment apparatus 350 for treating earth materials according to another embodiment. In the version of FIG. 3B, a conveyor 352 supports the earth material and moves the earth material through the apparatus 350 for microwave treatment. The microwave source 304 is similarly used to irradiate the earth material, and a similar feed preparation unit 323 can be used. The apparatus 350 can also have an enclosure to recover vapor, with similar condensing and optional purification units 326 and 327. Here, the earth material is disposed on the conveyor 352 in a thin layer such that microwaves can penetrate and expose all particles of the earth material as uniformly as possible. A spreader 354 of any suitable type can optionally be used to spread the earth material into a thin layer on the conveyor 352. Vapor can be collected and recycled using a similar recycling unit 329.

FIG. 3C is a schematic side view of a continuous flow microwave treatment apparatus 360 according to another embodiment. In the version of FIG. 3C, the earth material, mixed with polar liquid and sourced from the feed preparation unit 323, is provided to, and disposed into the interior of, a tubular processing unit 362. A blower unit 364 generates a gas flow in an axial direction of the processing unit 362 to fluidize the particles of the earth material previously moistened with the polar liquid in the mixing unit 316 (not shown for simplicity of the figure). The gas flow generated by the blower unit 364 transports the particles of the earth material along the tubular processing unit 362. A distribution member 366 may be disposed within the tubular processing unit 362, adjacent to the blower unit 364 and a feed point 368 of the processing unit 362, to distribute the particles of the earth material radially within the tubular processing unit 362 so that the particles are spaced apart as they travel the length of the processing unit 362. The distribution member 366 can be of any suitable variety, such as a mesh screen or series of mesh screens or a motorized bladed distributor, which can be a fan or turbine or can be just a spreader that does not otherwise propel the gas and earth particles itself.

A plurality of microwave radiation units 370 are disposed along an inner wall 372 of the tubular processing unit 362. Three microwave radiation units 370 are visible in the view of FIG. 3C, with a fourth microwave radiation unit 370 not shown for simplicity of the figure. The microwave radiation units 370 are oriented in an axial direction of the tubular processing unit 362, and extend in the axial direction along the inner wall 372 of the processing unit 362. The microwave radiation units 370, in this case, are azimuthally displaced, each from its two neighbors, by 90 degrees such that the four microwave radiation units 370 are uniformly spaced around the circumference of the inner wall 372.

Each microwave processing unit 362 has a plurality of microwave emitters 374 directionally oriented to radiate microwaves in a radial direction of the tubular processing unit 362 and in the axial direction of the tubular processing unit 362. In this case, each microwave emitter 374 is angled about 45 degrees with respect to the cylindrical axis of the tubular processing member 362. Also, in this case, the emitters 374 are uniformly spaced along the axial direction of the tubular processing unit 362 such that one of the microwave emitters 374 has an axial location, within the processing member 362, that is substantially the same as each corresponding emitter 374 on the other microwave radiation units 370. Thus, the microwave emitters 374 are arranged such that four of the emitters 374, one from each microwave radiation unit 370, form a group of emitters 374 located at substantially the same axial location of the processing unit 362.

The angled microwave emitters 374 emit microwaves that propagate in the axial direction of the tubular processing unit 362 in the same direction as the flow of the particles of the earth material within the tubular processing unit 362. Propagating the microwaves in a co-flow axial direction with the particles of the earth material increase exposure to, and absorption of, microwave photons by the particles of the earth material within the tubular processing unit 362 to improve energy efficiency of the apparatus 360. The tubular processing unit 362 may be made of, or may contain, microwave reflective materials and materials capable of resisting abrasion by the flowing particles of earth material. Microwave reflective materials, generally metals such as aluminum, stainless steel, copper, bronze, or other electrically conductive materials, facilitate microwave exposure within the tubular processing unit by confining the microwaves within the interior of the unit. Such materials can be coated, lined, or otherwise insulated from abrasion by flowing particles using materials that are substantially or completely transparent to microwaves, such as polished titanium, sapphire, quartz, or ceramics such as aluminum oxide and titanium dioxide. For example, the tubular processing unit 362 can be made of steel coated along the interior wall 372 with an abrasion resistant microwave non-absorbing material such as titanium dioxide. The microwave emitters 374 can be shielded from abrasion by coating the microwave emitters 374 with an abrasion resistant coating, such as a polished ceramic coating. The coating used may also be microwave non-absorbing, such as titanium oxide. Instead of a coating, a liner insert can be used. The liner insert can be abrasion resistant, made of any of the abrasion resistant, microwave transmissive materials described above, or the liner may be a sacrificial liner designed to be abraded and replaced periodically. Where the liner is designed as a sacrificial component, the liner may be a microwave reflective metal material.

In operations, as particles of the earth material, fluidized by the gas flow within the tubular processing member 362, flow along the length of the processing member 362, the earth particles interact with microwave photons radiated into the processing member 362 in the axial direction and the radial direction. As the earth particles flow down the axis of the processing member 362, the earth particles absorb microwaves according to their specific absorption properties and increase in temperature. The treated earth material particles flow out the distal end of the tubular processing unit 362 and are collected using any suitable means as the earth material 208, which can then be provided to the leaching process 202. A microwave reflector 376 can be positioned at, or within, the distal end of the tubular processing unit 362 to reflect any microwave photons that propagate to the distal end of the processing unit 362 back into the interior to be absorbed by the earth particles. The microwave reflector 376 is a member that allows the earth particles to pass through out of the processing unit 362 to be collected and forwarded for further processing. Thus, the microwave reflector 376 can be a metal mesh sized to reflect the microwaves propagating within the processing unit 362. As with the inner wall 372 of the tubular processing unit 362, the microwave reflector 376 can be coated with an abrasion resistant microwave non-absorbing material, such as polished titanium dioxide. Vapor can be collected and recycled using a similar recycling unit 329 as in the other figures.

FIG. 3D is a schematic side view of a microwave treatment apparatus 380 according to another embodiment. In the embodiment of FIG. 3D, the moistened earth material is provided to a cyclone 382 for microwave treatment. A plurality of microwave radiation units 384 are disposed around the cyclone to emit microwave photons into the interior of the cyclone. Here, the microwave radiation units 384 are shown extending vertically along the outer surface of the cyclone. The cyclone is made of a material that is microwave non-absorbent, such as titanium, and the internal surface of the cyclone may be coated with an abrasion-resistant microwave non-absorbent material, such as polished titanium oxide. The moist earth material is provided by the feed preparation unit 323 to an input tube 386 that is coupled to the cyclone in a tangential orientation perpendicular to a central axis of the cyclone 382. Here, the input tube 386 is coupled to the cyclone near an axial mid-point of the cyclone 382, but any feed point can be selected. A blower unit 388, or other gas source, provides a gas flow to transport the earth particles through the input tube into the interior of the cyclone 382.

The microwave radiation units 384, here, extend above and below the location where the input tube 386 couples to the cyclone 382 to provide microwave energy substantially throughout the cyclone 382. As in the embodiment of FIG. 3C, microwave emitters (not shown) of the microwave radiation units 386 may be angled with respect to the radial direction of the cyclone to propagate microwave photons in an axial direction of the cyclone. As usual, the cyclone operates by separating the solid earth particles to the interior wall of the cyclone, in near proximity to the microwave radiation units 384. Gas circulates within the cyclone vortically, and gas and solid particles generally separate according to density, so solid particles move downward in the cyclone while the gas moves upward. Thus, concentration of solid particles near the top of the cyclone is low so the microwave radiation units 384 are not extended to the top of the cyclone since microwave photons are not effective to treat a large number of the earth particles near the top of the cyclone, and should substantial microwave power be projected into the cyclone near the top thereof, where a low concentration of solid earth particles exists, those earth particles are likely to be over-exposed to microwave radiation. Near the bottom of the cyclone, solid particles flow to the narrow exit and form a thick layer, or fill the narrow exit entirely, so the microwave radiation units are not extended to the bottom of the cyclone to avoid non-uniform radiation exposure of the particles, and potential overheating of some particles. Here, the microwave radiation units extend approximately two-thirds of the way between the input location and the top of the cyclone, and extend approximately two-thirds of the way between the input location and the bottom of the cyclone. In this case, the microwave radiation emitters 384 extend along approximately two-thirds of the axial length of the cyclone, at the middle portion thereof.

The cyclone 382 can be operated to control thickness of a layer of solids at the inner wall of the cyclone to increase radiation exposure uniformity. By adjusting throughput of gas and solids, the inner wall layer thickness can be controlled and maintained below a tolerance thickness so that microwave exposure of the particles within the cyclone is as uniform as possible. The cyclone can be sized to allow a desired mass throughput while providing a desired wall layer thickness. Alternately, multiple microwave exposure cyclones can be connected in series. Along with flow rate of gas and solids, microwave power can be adjusted and/or modulated to control microwave exposure of the solid particles. In some cases, microwave power input, frequency, modulation, or other characteristics can be controlled based on thickness of the layer of solid particles at the inner wall of the cyclone to achieve a desired treatment rate and uniformity of treatment within the cycline.

It should be noted that, while four microwave radiation units 386 are shown in FIG. 3D, any suitable number of such units can be used in a cyclone configuration as shown in FIG. 3D. Also, while the microwave radiation units here are shown extending in an axial direction along the outer wall of the cyclone, the microwave radiation units can be configured in any convenient way. For example, microwave radiation units can be configured to extend horizontally around the outer wall of the cyclone, or in a spiral configuration. In another version, multiple discrete microwave emitters can be uniformly placed around the outer wall of the cyclone in any desired pattern. Combinations of such configurations can also be used.

As in the embodiments of FIGS. 3A and 3B, vapors released by microwave treatment of the earth particles in the apparatus of FIGS. 3C and 3D can be recovered and recycled using a configuration similar to that shown in FIG. 3A, where collected vapors are condensed in the condenser 326, optionally purified in the purifier 327, and returned to the polar liquid source 312.

Some methods described herein for extracting metal from an earth material include thermally treating the earth material to form an activated earth material; leaching a metal ion from the earth material or the activated earth material, or both, to form a dilute metal ion solution; and extracting the metal ion from the dilute metal ion solution using a selective extraction process to yield a concentrate. Other methods herein include obtaining a thermally-activated earth material; leaching a metal ion from a thermally-activated earth material to form a dilute metal ion solution; and extracting the metal ion from the dilute metal ion solution using a selective extraction process to yield a concentrate. Other methods here include obtaining a plasma-activated earth material; leaching a metal ion from a plasma-activated earth material to form a dilute metal ion solution; and extracting the metal ion from the dilute metal ion solution using a selective extraction process to yield a concentrate. The thermal treatment can include heating the earth material to a temperature of at least about 700° K., for example using an electric arc furnace, a microwave apparatus, or combination thereof. The metal ion can be lithium, and the selective extraction process can use a selective sorption-desorption or a selective electrochemical process to form an extract. A pretreatment can be performed on the dilute metal ion solution prior to the selective extraction process, for example using one or more of gravity separation, gas flotation, filtering, inducing coalescence, adsorption/desorption, and microbial processing.

Some methods herein also include converting the metal ion in the concentrate to a product, such as lithium carbonate, lithium hydroxide monohydrate, or both, which can be done using a conversion stage of the selective extraction process. A concentration of the metal ion in the extract, the concentrate, the product, or any combination thereof, can be increased as part of the methods herein. The activated earth material can be polymerized, for example following metals removal.

Leaching can include contacting the earth material with an organic solvent. Leaching can include mixing the activated earth material with a leaching fluid to form a mixture and milling the mixture. Leaching can be performed in a leaching stage using an organic solvent as a leaching fluid to form a loaded leaching fluid and contacting the loaded leaching fluid with an aqueous fluid, which can be a material obtained from the selective extraction process, to transport metal ions from the loaded leaching fluid to the aqueous fluid to form the dilute metal ion solution. Where an organic solvent is used for leaching, the organic solvent can be separated from the metal ion using an aqueous material, which as above can be obtained from the selective extraction process.

While the foregoing is directed to embodiments of the present invention, other and further embodiments of the present disclosure may be devised without departing from the basic scope thereof, and the scope thereof is determined by the claims that follow.

We claim:

1. A method, comprising:
obtaining a thermally treated earth material containing a metal;
removing the metal from the thermally treated earth material to form a dilute metal solution; and
recovering the metal from the dilute metal solution or a derivative thereof using a selective recovery process.

2. The method of claim 1, wherein removing the metal from the thermally treated earth material also forms an alkali reactive earth material, and the method further comprises forming an aluminosilicate polymer from the alkali reactive earth material.

3. The method of claim 1, wherein obtaining the thermally treated earth material comprises treating an earth material using plasma, microwaves, or both.

4. The method of claim 1, wherein removing the metal from the thermally treated earth material comprises leaching the metal from the thermally treated earth material using a leaching fluid that is an organic solvent or an aqueous material having pH less than about 9.

5. The method of claim 4, wherein the leaching fluid is a low-boiling alcohol.

6. The method of claim 4, wherein the leaching fluid is an organic solvent and the method further includes separating the organic solvent from the metal ion using an aqueous material.

7. The method of claim 6, wherein the aqueous material is obtained from the selective extraction process.

8. The method of claim 3, wherein the selective recovery process uses a sorption-desorption process, an electrochemical process, or both, to form an extract containing the metal.

9. The method of claim 1, wherein obtaining the thermally treated earth material comprises processing an earth material at a temperature of at least 600 K.

10. The method of claim 1, wherein obtaining the thermally treated earth material comprises processing an earth material at a temperature of at least 3,500 K.

11. The method of claim 1, wherein obtaining the thermally treated earth material comprises treating the earth material in a continuous flow microwave apparatus.

12. The method of claim 11, further comprising mixing the earth material with a polar liquid to form a solid-liquid mixture and treating the solid-liquid mixture in the continuous flow microwave process.

13. The method of claim 1, wherein thermally treating the earth material comprises performing a plasma treatment on the earth material, and the plasma treatment comprises fluidizing the earth material in an ionizable gas.

14. The method of claim 1, wherein obtaining the thermally treated earth material comprises performing a flash calcination process on an earth material.

15. The method of claim 1, wherein removing the metal from the thermally treated earth material comprises mixing the thermally treated earth material with a leaching fluid to form a mixture and milling the mixture.

16. The method of claim 8, further comprising converting the metal of the extract, or a derivative thereof, into a product.

17. The method of claim 1, wherein the selective recovery process comprises performing a pretreatment process on the dilute metal solution, the pretreatment process optionally selected from the group consisting of gravity separation, gas flotation, filtering, inducing coalescence, adsorption/desorption, microbial processing, or a combination thereof.

18. The method of claim 1, wherein the metal is lithium.

19. The method of claim 18, wherein the product is lithium carbonate, lithium hydroxide monohydrate, or both.

20. The method of claim 1, wherein the selective recovery process further comprises increasing a concentration of the metal, optionally using membrane separation processes or evaporation.
